(19) United States
(12) Patent Application Publication
(10) Pub. No.: US 2019/0291807 A1
(43) Pub. Date: Sep. 26, 2019

(54) FOLDABLE CYCLE ASSEMBLY

(71) Applicant: GM GLOBAL TECHNOLOGY OPERATIONS LLC, Detroit, MI (US)

(72) Inventors: Radu D. Sotir, Toronto (CA); Goerge Floarea, Whitby (CA)

(21) Appl. No.: 15/925,912

(22) Filed: Mar. 20, 2018

(51) Int. Cl. B62K 15/00; B62K 21/22

(52) U.S. Cl. CPC B62K 15/006; B62K 21/22

(57) ABSTRACT

A cycle includes a foldable frame having a hinge between a fore portion and an aft portion. The frame is movable between folded and unfolded positions. A front fork with a first central axis is pivotably coupled to the fore portion. A handlebar stem with a second central axis is rotatably and slidably coupled to the front fork. The second central axis is non-coaxial with the first central axis. A seat post is slidably coupled to the aft portion. The fore portion has first and second apertures therethrough. When the frame is in the folded position, the handlebar stem may be disposed at least partially within the first aperture to thereby secure the front fork relative to the frame, and the seat post may be disposed at least partially within the second aperture to thereby secure the frame in the folded position.

### TECHNICAL FIELD

The field to which the disclosure generally relates includes cycles, and more particularly, includes cycles with folding features.

### INTRODUCTION

Cycles may come in a variety of forms that may be propelled through manual power, machine power, or both. Reconfiguring a cycle to a compact form may be desirable for storage or transportation. The mechanisms that enable reconfiguration tend to be complex, and operation of the mechanisms may be time consuming. As a result, new approaches to enable reconfiguration are desirable.

### SUMMARY

A folding bicycle according to the present disclosure includes a foldable frame having a fore portion, an aft portion, and a hinge disposed between the fore portion and an aft portion. The frame is movable between a folded position and an unfolded position. The bicycle includes a front fork pivotably coupled to the fore portion. The front fork is pivotable about a first central axis. A first wheel is rotatably coupled to the front fork, and a second wheel is rotatably coupled to the aft portion. The bicycle also includes a handlebar stem rotatably and slidably coupled to the front fork. The handlebar stem has a second central axis and is slidable along the second central axis between a first deployed position and a first retracted position relative to the frame. The second central axis is non-coaxial with the first central axis. The bicycle additionally includes a seat post slidably coupled to the aft portion. The seat post is slidable between a second deployed position and a second retracted position relative to the frame. The fore portion has a first aperture therethrough and a second aperture therethrough. When the frame is in the folded position, the handlebar stem in the first retracted position, and the seat post in the second retracted position, the handlebar stem is disposed at least partially within the first aperture to thereby secure the front fork relative to the frame, and the seat post is disposed at least partially within the second aperture to thereby secure the frame in the folded position.

In an exemplary embodiment, the second central axis is not parallel to the first central axis.

In an exemplary embodiment, the handlebar stem has a noncircular cross-sectional profile, and the first aperture has a corresponding noncircular profile. In such embodiments, the frame may have a frame long axis, and the handlebar stem may be coupled to a handlebar assembly having a handlebar long axis. In such embodiments, the handlebar stem has an elliptical profile with a stem long axis oriented generally parallel to the handlebar long axis, and the first aperture has an elliptical profile with an aperture long axis oriented generally parallel to the frame long axis.

In an exemplary embodiment, the frame comprises a main tube, a head tube, and a bracket coupling the main tube to the head tube. The front fork is pivotably coupled to the head tube, and the first aperture and second aperture are disposed in the bracket.

In an exemplary embodiment, the bicycle additionally includes a first clamp member and a second clamp member. The first clamp member is configured to selectively restrict relative motion between the seat post and the aft portion, and the second clamp member is configured to selectively restrict relative motion between the handlebar stem and the front fork.

In an exemplary embodiment, the frame comprises a seat tube having a third central axis. The seat post is disposed at least partially within the seat tube. With the frame in the folded position, the third central axis is aligned with the second aperture.

In an exemplary embodiment, the hinge has a pivot axis and the rear wheel has an axis of rotation, with the pivot axis and axis of rotation being generally parallel.

A cycle assembly according to the present disclosure includes a frame. The frame has at least one main tube extending from a fore portion to an aft portion and a head tube coupled to the fore portion. The head tube has a first central axis. The frame ios provided with an aperture therethrough. The cycle assembly additionally includes a front fork pivotably coupled to the head tube and pivotable about the first central axis. The cycle assembly further includes a handlebar stem rotatably and slidably coupled to the front fork. The handlebar stem has a second central axis and is slidable along the second central axis between a deployed position and a retracted position relative to the frame. The second central axis is non-coaxial with the first central axis. When in the retracted position the handlebar stem is disposed at least partially in the aperture.

In an exemplary embodiment, the cycle assembly additionally includes a hinge disposed between the fore portion and the aft portion. In such embodiments, the main tube is movable between a folded position and an unfolded position.

In an exemplary embodiment, the second central axis is not parallel to the first central axis.

In an exemplary embodiment, the handlebar stem has a noncircular cross-sectional profile, and the aperture has a corresponding noncircular profile. In such embodiments, the frame may have a frame long axis, and the handlebar stem may be coupled to a handlebar assembly having a handlebar long axis. In such embodiments, the handlebar stem has an elliptical profile with a stem long axis oriented generally parallel to the handlebar long axis, and the first aperture has an elliptical profile with an aperture long axis oriented generally parallel to the frame long axis.

In an exemplary embodiment, the frame includes a bracket coupling the main tube to the head tube, and the aperture is provided through the bracket.

A cycle assembly according to the present disclosure includes a frame having at least one main tube extending from a fore portion to an aft portion. The frame has a hinge disposed between the fore portion and the aft portion. The main tube is movable between a folded position and an unfolded position. The frame includes a head tube coupled to the fore portion and a seat tube coupled to the aft portion. The seat tube has a central axis. The frame is provided with an aperture therethrough proximate the fore portion. The assembly additionally includes a seat post disposed at least partially within the seat tube. The seat post is slidable between a deployed position and a retracted position relative to the frame. With the main tube in the folded position, the central axis is aligned with the second aperture. With the seat post in the retracted position, the seat post is disposed at least partially in the first aperture to thereby secure the main tube in the folded position.

In an exemplary embodiment, the frame includes a bracket coupling the main tube to the head tube, and the aperture is provided through the bracket.

Embodiments according to the present disclosure provide a number of advantages. For example, the present disclosure provides a folding frame for a cycle which may provide a compact and portable package, while also providing a simple yet robust mechanism for securing the cycle in a folded position.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 illustrates an unfolded configuration of a foldable cycle according to an embodiment of the present disclosure;

FIG. 2 illustrates a first intermediate folding step of a foldable cycle according to an embodiment of the present disclosure;

FIG. 3 illustrates a second intermediate folding step of a foldable cycle according to an embodiment of the present disclosure; and

FIG. 4 illustrates a folded configuration of a foldable cycle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desirable for particular applications or implementations.

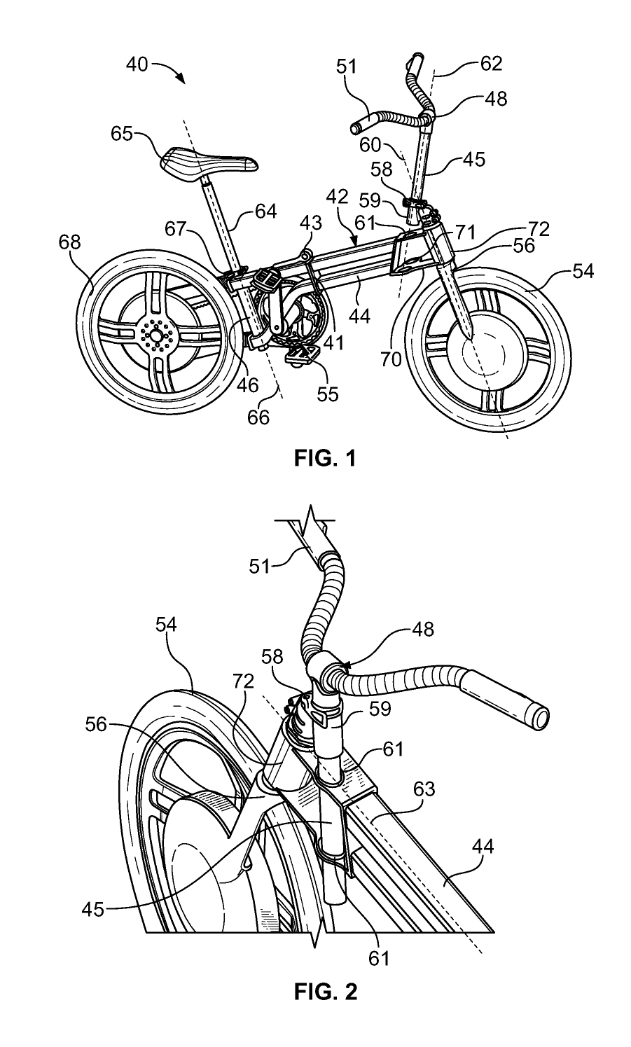

FIG. 1 illustrates a cycle 40 according to an embodiment of the present disclosure. In the illustrated embodiment the cycle 40 is a bicycle having a front wheel 54 and a rear wheel 68; however, in other embodiments other numbers or arrangements of wheels may be provided. The cycle 40 includes a frame 42 with a main tube 44 connected to a seat tube 46 and a head tube 72. The main tube 44 includes a hinged joint 41 to enable folding the frame 42, so that the cycle 40 may be more easily transported and stored. The hinged joint 41 is disposed between the seat tube 46 and the head tube 72, such that the seat tube 46 is coupled to a rear portion of the main tube 44 and the head tube 72 is coupled to a front portion of the main tube 44. A latch release 43 may be provided to selectively unlatch the joint 41. In the illustrated embodiment the main tube 44 comprises an upper tubular member and a lower tubular member, each coupled to the hinged joint 41. However, in other embodiments the main tube 44 may comprise one or more tubular members.

The cycle 40 includes a propulsion system 55. In various embodiments, the propulsion system 55 may operate on manual inputs, motor powered inputs, or a combination thereof. The propulsion system 55 may include a crank assembly with a crankshaft connected with first and second pedal assemblies. In addition, the propulsion system 55 may include a motor powered unit that may augment or supplant manual inputs.

A front fork 56 is pivotably coupled to the main tube 44 via the head tube 72. The head tube 72 has a central axis 60, which may also be referred to below as a first axis. The front fork 56 extends generally along the first axis 60, which may also define the pivot axis of the front fork 56 relative to the head tube 72. The front fork 56 may be coupled to a front wheel 54. The front fork is provided with a sleeve 59 and a first clamp member 58.

A handlebar stem 45 disposed partially within the sleeve 59 and is releasably coupled to the front fork 56 by means of the first clamp member 58. The sleeve 59 comprises a tubular section within which the handlebar stem 45 may slide. In the illustrated embodiment the first clamp member 58 comprises a quick-release clamp; however, in other embodiments other clamping devices may be used. The first clamp member 58 may be released to permit relative motion between the handlebar stem 45 and the front fork 56, or engaged to restrict relative motion therebetween.

The handlebar stem 45 extends generally along a second axis 62. The second axis 62 is not coaxial with the first axis 60. In the illustrated embodiment the second axis 62 is not parallel to the first axis 60. However, in other embodiments the second axis 62 may be parallel to and offset from the first axis 60. When the first clamp member 58 is released, the handlebar stem 45 may thereby slide along the second axis 62 without interference from the front fork 56.

The main tube 44 is provided with a bracket 70 having at least one handlebar stem aperture 61. In the illustrated embodiment, the bracket 70 is positioned foreword of the joint 41 and couples the main tube 44 to the head tube 72; however, in other embodiments the bracket 70 may be disposed in other locations. In the illustrated embodiment the bracket 70 is provided with two handlebar stem apertures 61; however, in other embodiments, a greater or lesser number of handlebar stem apertures 61 may be provided. The handlebar stem aperture 61 is aligned with the second axis 62 and is sized to receive the handlebar stem 45. When the first clamp member 58 is released, the handlebar stem 45 may translate toward the bracket 70 and slide into the handlebar stem aperture 61. The first clamp member 58 may then be re-engaged to secure the handlebar stem 45 in the new position.

In an exemplary embodiment, the handlebar stem aperture 61 has a non-circular profile, and the handlebar stem 45 has a corresponding non-circular cross-section profile. In the embodiment illustrated in FIG. 2, the handlebar stem aperture 61 has an elliptical profile with a long axis 63 extending generally parallel to the main tube 44, and the handlebar stem 45 has a corresponding elliptical profile with a long axis extending generally parallel to a handlebar assembly 48 and a pair of opposed handles 51. The handlebar assembly 48 is coupled to the handlebar stem 45 and may be used to control the direction of the front wheel 54 by way of the front fork 56. In such embodiments, the orientation of the handlebar stem 45 and handlebar assembly 48 relative to the main tube 44 may thereby be controlled when the handlebar stem 45 is disposed in the handlebar stem aperture 61. Other embodiments contemplated within the scope of the present disclosure may include handlebar stems with other non-circular profiles to achieve similar effect, or indeed may include handlebar stems with circular profiles.

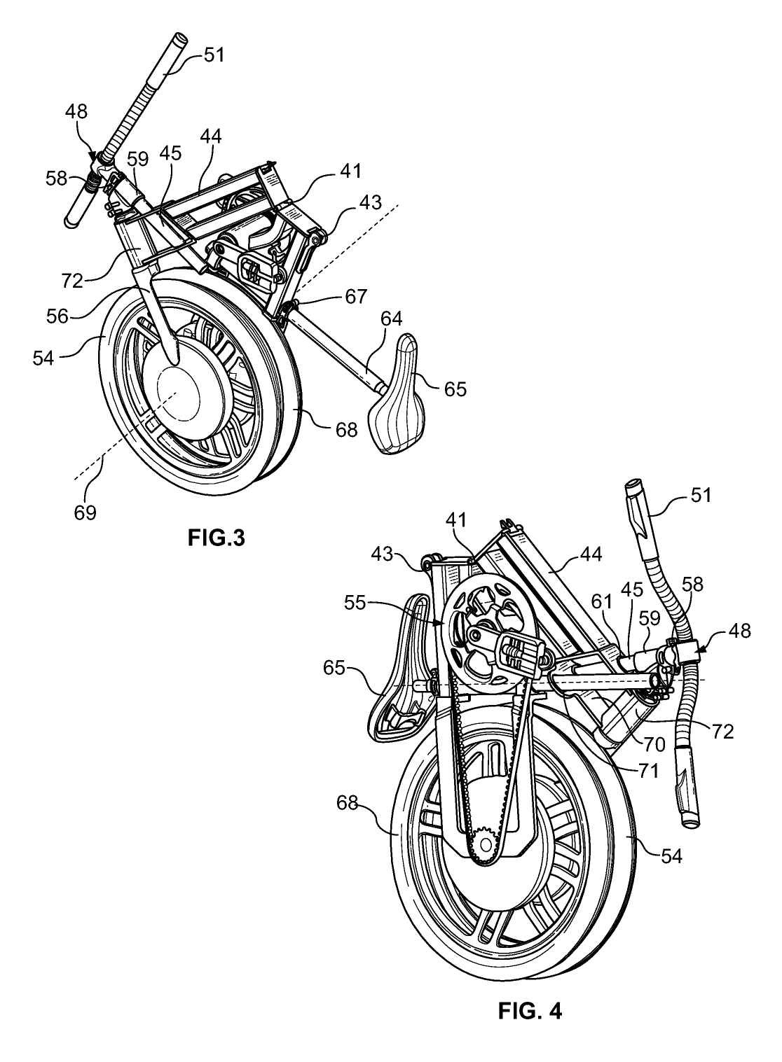

In the illustrated embodiment, the joint 41 has a pivot axis with a similar orientation to the axis of rotation of the rear wheel 68. This arrangement may be referred to as a “vertical fold” frame. Moreover, in the illustrated embodiment, the joint 41 has a pivot axis which is not orthogonal to the central axis of the main tube 44. As a result, when the main tube 44 is folded about the joint 41, the front wheel 54 and rear wheel 68 may be generally aligned along a common central axis 69, as illustrated in FIG. 3.

A seat post 64 may be disposed within the seat tube 46. The seat post 64 may be provided with a seat 65 which is configured to support a rider of the cycle 40. The seat post 64 is slidable relative to the seat tube 46 along a third axis 66. A second clamp member 67 is coupled to the seat tube 46. The second clamp member 67 may be released to permit relative motion between the seat post 64 and the seat tube 46, or engaged to restrict relative motion therebetween. When the second clamp member 67 is released, the seat post 64 may thereby slide along the third axis 66 to raise or lower relative to the seat tube 46.

The bracket 70 is provided with at least one seat post aperture 71. In the illustrated embodiment the bracket 70 is provided with one seat post aperture 71; however, in other embodiments, a greater number of seat post apertures 71 may be provided. When the frame 42 is in the folded position as illustrated in FIGS. 3 and 4, the seat post aperture 71 is aligned with the third axis 66. The seat post aperture 71 is sized to receive the seat post 64. When the second clamp member 67 is released, the seat post 64 may translate toward the bracket 70 and slide into the seat post aperture 71. The second clamp member 67 may then be re-engaged to secure the seat post 64 in the new position. Advantageously, the seat post 64 may, when inserted into the seat post aperture 71 and secured in place by the second clamp member 67, retain the frame 42 in the folded position.

As may be seen in FIG. 4, for example, when fully folded the axles of the wheels 54, 68 are aligned. This configuration may be conducive for straight wheel tracking for convenient transportation, e.g. dollying. Moreover, the engagement of seat post 64 and seat post aperture 71 secures the frame in the folded position, while the insertion of the handlebar stem 45 into the handlebar stem aperture 61 results in a compact assembly. Furthermore, conversion between folded and unfolded position requires manipulation of a relatively small number of elements, e.g. the latch release 43, first clamp member 58, and second clamp member 67.

As may be seen, the present disclosure provides a folding frame for a cycle which may provide a compact and portable package, while also providing a simple yet robust mechanism for securing the cycle in a folded position.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A folding bicycle comprising:
a foldable frame having a fore portion, an aft portion, and a hinge disposed between the fore portion and the aft portion, the frame being movable between a folded position and an unfolded position;
a front fork pivotably coupled to the fore portion, the front fork being pivotable relative to the fore portion about a first central axis;
a first wheel rotatably coupled to the front fork;
a second wheel rotatably coupled to the aft portion;
a handlebar stem rotatably and slidably coupled to the front fork, the handlebar stem having a second central axis and being slidable along the second central axis between a first deployed position and a first retracted position relative to the frame, the second central axis being non-coaxial with the first central axis;
a seat post slidably coupled to the aft portion, the seat post being slidable between a second deployed position and a second retracted position relative to the frame;
wherein the fore portion has a first aperture therethrough and a second aperture therethrough, wherein with the frame in the folded position, the handlebar stem in the first retracted position, and the seat post in the second retracted position, the handlebar stem is disposed at least partially within the first aperture to thereby secure the front fork relative to the frame and the seat post is disposed at least partially within the second aperture to thereby secure the frame in the folded position.

2. The folding bicycle of claim 1, wherein the second central axis is not parallel to the first central axis.

3. The folding bicycle of claim 1, wherein the handlebar stem has a noncircular cross-sectional profile, and wherein the first aperture has a corresponding noncircular profile.

4. The folding bicycle of claim 3, wherein the frame has a frame long axis, the handlebar stem is coupled to a handlebar assembly having a handlebar long axis, the handlebar stem has an elliptical profile with a stem long axis oriented generally parallel to the handlebar long axis, and the first aperture has an elliptical profile with an aperture long axis oriented generally parallel to the frame long axis.

5. The folding bicycle of claim 1, wherein the frame comprises a main tube, a head tube, and a bracket coupling the main tube to the head tube, the front fork being pivotably coupled to the head tube, the first aperture and second aperture being disposed in the bracket.

6. The folding bicycle of claim 1, further comprising a first clamp member configured to selectively restrict relative motion between the seat post and the aft portion, and a second clamp member configured to selectively restrict relative motion between the handlebar stem and the front fork.

7. The folding bicycle of claim 1, wherein the frame comprises a seat tube having a third central axis, the seat post being disposed at least partially within the seat tube, wherein with the frame in the folded position, the third central axis is aligned with the second aperture.

8. The folding bicycle of claim 1, wherein the hinge has a pivot axis and the second wheel has an axis of rotation, the pivot axis and axis of rotation being generally parallel.

9. A cycle assembly comprising:
a frame having at least one main tube extending from a fore portion to an aft portion and a head tube coupled to the fore portion, the head tube having a first central axis, the frame being provided with an aperture therethrough;
a front fork pivotably coupled to the head tube and pivotable about the first central axis; and
a handlebar stem rotatably and slidably coupled to the front fork, the handlebar stem having a second central axis and being slidable along the second central axis between a deployed position and a retracted position relative to the frame, the second central axis being non-coaxial with the first central axis, wherein when in the retracted position the handlebar stem is disposed at least partially in the aperture.

10. The cycle assembly of claim 9, further comprising a hinge disposed between the fore portion and the aft portion, wherein the main tube is movable between a folded position and an unfolded position.

11. The cycle assembly of claim 9, wherein the second central axis is not parallel to the first central axis.

12. The cycle assembly of claim 9, wherein the handlebar stem has a noncircular cross-sectional profile, and wherein the aperture has a corresponding noncircular profile.

13. The cycle assembly of claim 12, wherein the frame has a frame long axis, the handlebar stem is coupled to a handlebar assembly having a handlebar long axis, the handlebar stem has an elliptical profile with a stem long axis oriented generally parallel to the handlebar long axis, and the aperture has an elliptical profile with an aperture long axis oriented generally parallel to the frame long axis.

14. The cycle assembly of claim 9, wherein the frame includes a bracket coupling the main tube to the head tube, and wherein the aperture is provided through the bracket.

15. A cycle assembly comprising:
a frame having at least one main tube extending from a fore portion to an aft portion, a hinge disposed between the fore portion and the aft portion, the main tube being movable between a folded position and an unfolded position, a head tube coupled to the fore portion, and a seat tube coupled to the aft portion, the seat tube having a central axis, the frame being provided with an aperture therethrough proximate the fore portion;
a seat post disposed at least partially within the seat tube, the seat post being slidable between a deployed position and a retracted position relative to the frame, wherein with the main tube in the folded position, the central axis is aligned with the aperture, and with the seat post in the retracted position the seat post is disposed at least partially in the aperture to thereby secure the main tube in the folded position.

16. The cycle assembly of claim 15, wherein the frame includes a bracket coupling the main tube to the head tube, and wherein the aperture is provided through the bracket.
